(19) United States
(12) Patent Application Publication
(10) Pub. No.: US 2024/0242544 A1
(43) Pub. Date: Jul. 18, 2024

(54) SYSTEM FOR MONITORING THE PROCESSES PERFORMED BY AT LEAST ONE MACHINE AND THE PROCESS ENVIRONMENT

(71) Applicant: ABAUT GMBH, Munich (DE)

(72) Inventors: Markus Häupl, Sattendorf (AT); Matthias Wimmer, Munich (DE); Sebastian Kaluza, Fürstenfeldbruck (DE); Max-David Falkner, Munich (DE)

(73) Assignee: ABAUT GMBH, Munich (DE)

(21) Appl. No.: 18/289,858

(22) PCT Filed: May 6, 2022
(86) PCT No.: PCT/EP2022/062333

§ 371 Date: Nov. 7, 2023

(30) Foreign Application Priority Data
May 7, 2021 (DE) 10 2021 112 052.7

(51) Int. Cl. G07C 3/00; G06T 7/00

(52) U.S. Cl. CPC G07C 3/005; G06T 7/0004

(57) ABSTRACT

The present invention relates to a system (100) for monitoring the processes performed by at least one machine (14, 16, 18, 20) and the process environment, the at least one machine (14, 16, 18, 20) being applicable on a construction site and/or in mining, the system (100) comprising: at least one sensor unit (10), the at least one sensor unit (10) being configured to determine information relating to the at least one machine (14, 16, 18, 20), the information determined by the at least one sensor unit (10) comprising at least one item of information from the following group: Position information of the machine (14, 16, 18, 20), at least one speed value in at least one direction, at least one acceleration value in at least one direction, at least one camera (22, 24, 26, 28) generating image data comprising at least a portion of the at least one machine (14, 16, 18, 20) and/or at least a section of the process environment of the at least one machine (14, 16, 18, 20), and at least one evaluation unit (12), the at least one evaluation unit (12) being configured to merge the information determined by the at least one sensor unit (10) and the image data generated by the at least one camera (22, 24, 26, 28) at least for monitoring the processes carried out by the at least one machine (14, 16, 18, 20) and the process environment.

The present invention relates to a system for monitoring the processes performed by at least one machine and the process environment. The system may be used to monitor the processes performed by a plurality of machines and the process environment of the machines. The at least one machine may be used on construction sites and/or in mining operations. The present invention further relates to a sensor arrangement for such a system.

Machines that can be used on construction sites and/or in mining operations can be machines such as excavators, wheel loaders, trucks and tippers or dumpers. These machines can perform different processes at different locations on the construction site or mining operation. Construction sites, and mining operations in particular, may be relatively large and/or located in remote locations. As a result, monitoring the processes performed by the machines and the process environment can be difficult and, if at all, can only be carried out with a relatively large amount of effort.

It is an object of the present invention to provide a system for monitoring the processes performed by at least one machine and the process environment, which enables monitoring of the processes performed by the at least one machine and the process environment, independent of the site of operation of the at least one machine.

This object is solved by a system for monitoring the processes carried out by at least one machine and the process environment with the features of claim 1.

Further embodiments are given in the dependent claims.

The system according to the invention for monitoring the processes carried out by at least one machine and the process environment comprises at least one sensor unit, wherein the at least one sensor unit is configured to determine information relating to the at least one machine, wherein the information determined by the at least one sensor unit comprises at least one information from the following group: position information of the machine, at least one velocity value in at least one direction, at least one acceleration value in at least one direction.

The system further comprises at least one camera that generates image data. The image data includes at least a portion of the at least one machine and/or at least a section of the process environment of the at least one machine.

The system also has at least one evaluation unit. The at least one evaluation unit is configured to merge the information determined by the at least one sensor unit and the image data generated by the at least one camera for monitoring the processes carried out by the at least one machine and the process environment.

With the system according to the invention, the processes carried out by the at least one machine and the process environment can be monitored and analysed essentially without gaps in real time or at least in near real time, even at the most remote sites of operation. For this purpose, the information determined by the at least one sensor unit and the image data generated by the at least one camera are merged by the at least one evaluation unit independently of the site of operation of the at least one machine in order to be able to analyse the processes carried out by the at least one machine and the process environment. The monitoring of the processes carried out by the at least one machine can be synchronised in time with the monitoring of the processes of other machines.

In this context, process environment can be understood as the environment or at least a section of the environment in which the at least one machine executes the processes assigned to it.

The at least one machine can be a machine that can be used on a construction site or in mining. The at least one machine can change its position and/or perform movements with at least one section. Accordingly, the machines may also be vehicles.

The at least one evaluation unit can be configured to merge the information determined by the at least one sensor unit and the image data generated by the at least one camera in order to determine a process profile of the at least one machine. By merging the information determined by the sensor unit and the image data, a holistic process profile of the machine can be generated. For example, it can be determined for the process profile at which position the machine executed which process and whether the execution of the processes was influenced by the state of the process environment or by encounters or interactions with other machines. By merging the image data from the at least one camera and the information from the at least one sensor unit, it is possible, for example, to analyse a process carried out by the machine, the material processed/transported by the machine and/or the state of the process environment.

The at least one evaluation unit can be configured to recognise objects in the image data recorded by the at least one camera and to distinguish between them. The evaluation unit can also be configured to recognise persons in the image data generated by the at least one camera. The at least one evaluation unit may be configured to mask and/or otherwise render the recognised persons unrecognisable. Accordingly, the system can fulfil the requirements of the General Data Protection Regulation (GDPR).

The at least one evaluation unit can be configured to recognise machines in the image data determined by the at least one camera. The at least one evaluation unit can assign the machines determined in the image data to different machine types. For example, the at least one evaluation unit can distinguish between excavators, wheel loaders, trucks and tippers or dumpers.

The at least one evaluation unit can be configured to merge the information determined by the at least one sensor unit and the image data generated by the at least one camera in order to determine information about the process environment of the at least one machine. A state model of the process environment of the machine can be determined on the basis of the information determined by the at least one sensor unit and the image data generated by the camera. Based on the determined state model of the process environment, the effects of the state of the process environment, such as the state of the ground or the travel path, on the processes executed by the at least one machine and the process performance can be determined. For example, the at least one evaluation unit can determine increased acceleration values for certain areas of the travel path based on the information determined by the at least one sensor unit. In the image data generated by the at least one camera, the trigger or cause of the increased acceleration values can be determined by the at least one evaluation unit. In this way, for example, potholes in the travel path of the at least one machine can be determined that have caused the increased acceleration values. The at least one evaluation unit can also determine the effects resulting from the potholes on the process performance of the machine, such as on the process speed of the machine. Based on the determined information about the process environment of the at least one machine, alternative routes can be specified for the machine, the equipment of the machine can be adapted to the condition of the process environment or the repair of a route can be initiated.

The at least one evaluation unit can be configured to determine at least the type and/or at least one characteristic of the material processed or handled by the at least one machine based on the information determined by the at least one sensor unit and the image data generated by the at least one camera. The material processed or handled by the at least one machine may be, for example, rock, construction raw materials or excavated earth. Accordingly, the at least one evaluation unit may be configured to perform an analysis of the material based on the information determined by the at least one sensor unit and the image data generated by the at least one camera. Properties of the material may be, for example, the particle size, the soil class, or the homogeneity ranges of the soils. In other words, the analysis of the material may be based on the information from the sensor unit merged with the image data from the camera. For example, the acceleration values determined by the at least one sensor unit may be assigned with the rock and/or the size of the rock particles contained in the image data of the camera. Based on the information obtained in this way, it can be determined, for example in mining, that the blasting parameters must be changed in order to obtain smaller or finer rock particles.

The at least one sensor unit can be configured to control the at least one camera. The at least one sensor unit can be configured to control the at least one camera based on at least one information determined by the at least one sensor unit. The at least one sensor unit may be configured to control the at least one camera based on an event detected by the sensor unit. Therefore, the size and quantity of information packets or image data packets that can be transmitted to the evaluation unit can be reduced. For example, the frame rate, the image quality or the image resolution can be reduced. Such an event may be indicated by the information captured by the sensor unit. Such an event may be, for example, an acceleration value exceeding a threshold value or a detected encounter with another machine. The at least one sensor unit may be configured to instruct the at least one camera to generate image data for an image or an image sequence in dependence on the information detected by the at least one sensor unit respectively independence on an event. The at least one evaluation unit can be configured to assign an image or an image sequence of the image data generated by the at least one camera to at least one information determined by the at least one sensor unit. The at least one camera may be a stereo camera.

The control of the at least one camera can be machine-specific or machine type-specific. Different information specific for the respective machine type can be used for controlling the camera, which can be determined by the at least one sensor unit. The information used by the at least one sensor unit to control the at least one camera can be different for an excavator or a dump truck, for example.

The at least one sensor unit can be configured to activate or deactivate the at least one camera in dependence on at least one information determined by the sensor unit. For example, if information determined by the sensor unit shows a certain process, the sensor unit can activate or deactivate the at least one camera. For example, if it is determined on the basis of at least one information detected by the sensor unit that a dump truck has reached the location of an excavator and a loading process is to take place, the camera of the excavator can be activated.

The at least one evaluation unit can be configured to determine information patterns in the information determined by the at least one sensor unit. The at least one evaluation unit can be configured to assign the image data generated by the at least one camera to one or more determined information patterns. The at least one evaluation unit can be configured to determine a process executed by the machine on the basis of the determined information patterns. A machine may exhibit a certain behaviour during a certain process. This behaviour may be reflected in the information determined by the at least one sensor unit. The at least one evaluation unit can analyse the information determined by the at least one sensor unit for specific information patterns.

The at least one camera can transmit the image data it generates to the at least one sensor unit. The at least one sensor unit can transmit the information determined by it and the image data of the camera to the at least one evaluation unit or make it available to the at least one evaluation unit for retrieval. The at least one camera can be configured to transmit the image data determined by it to the at least one evaluation unit.

The at least one sensor unit can communicate wirelessly with the at least one evaluation unit directly or indirectly. For example, the at least one sensor unit can communicate with the at least one evaluation unit via radio networks and/or mobile radio networks. However, the at least one sensor unit can also communicate with the at least one evaluation unit via other wireless communication protocols or communication methods. The same also applies to the at least one camera, which can communicate wirelessly with the at least one evaluation unit directly or indirectly. Communication between the at least one camera and the at least one evaluation unit can also take place via radio networks and/or mobile radio networks.

The position information of the at least one machine can be the geo-position of the machine. The position information can be determined with a GNSS receiver. The at least one sensor unit may further communicate with radio cells to determine the position information. The position information can also be determined via Wifi-beacons, Wifi-triangulation, Wifi-trilateration, Bluetooth®-beacons, Bluetooth®-triangulation, Bluetooth®-trilateration and via ultra-wide-band (UWB). Furthermore, the position information can also be determined via other radio standards.

The at least one sensor unit may be arranged on a machine. The at least one camera may be arranged on a machine. The at least one sensor unit and the at least one camera may be attached on the same machine. The at least one camera may communicate with the at least one sensor unit via cable or wirelessly.

The at least one camera can be arranged stationary at a predetermined location. Same applies to the at least one sensor unit, which can also be arranged stationary at a predetermined location. The at least one camera and the at least one sensor unit can be arranged stationary at the same location. For example, the at least one camera and the at least one sensor unit may be arranged on a pole. From this location, the at least one camera can generate image data relating to at least one machine and/or the process environment.

The at least one evaluation unit may have an artificial intelligence unit. The artificial intelligence (AI) unit may execute AI-methods in the form of machine learning or neural networks. These AI methods are trained based on a database, i.e. based on training data, which includes input information and the predefined result. Neural networks and further AI-methods can have abstracting or generalising properties, i.e. they can also output a plausible result to a certain extent for unknown situations. The information determined by the at least one sensor unit and the image data generated by the at least one camera can be merged and evaluated with the help of sensor fusion algorithms or artificial intelligence.

The at least one acceleration value in at least one direction can be determined during a movement of the machine or during a movement of at least one part of the machine. For example, in a hydraulic excavator, the movable part is formed by the upper carriage of the hydraulic excavator. For example, in an excavator, the at least one acceleration value may be determined when the bucket of the excavator is actuated. The at least one sensor unit may be configured to determine acceleration values in at least three directions, i.e. in x-, y-, z-direction. The information that can be determined by the at least one sensor unit may comprise at least one speed value. The information determinable by the at least one sensor unit may comprise the orientation and/or position of the machine or the orientation and/or position of at least one part of the machine. For example, in a hydraulic excavator, the 3600 rotatable upper carriage represents a part of the machine that can change its orientation and/or position independently of the wheels or tracks. Further, information about the process environment of the machine that can be determined by the at least one sensor unit may comprise information about the process environment of the machine. Such information about the process environment may be, for example, the air pressure and the temperature. Information about the process environment can also be determined using a magnetometer. This can be used to determine the compass direction. In particular, the magnetometer may be a 3-axis magnetometer.

The system may comprise multiple sensor units and/or multiple cameras, which may be arranged on multiple machines. At least some of the sensor units and/or some of the cameras may be arranged on a machine.

The at least one evaluation unit can be configured to determine two or more interacting machines based on the information determined by the multiple sensor units and/or based on the image data generated by the at least one camera. The at least one evaluation unit can thus also detect based on information patterns and/or based on the image data when two machines are working together or interacting. Interacting or cooperating machines can generate certain information patterns that can be determined by the at least one evaluation unit. These determined information patterns can, for example, be classified as an event that results in an activation of the at least one camera.

The system can monitor the at least one machine independently of internal machine parameters of the at least one machine. In other words, the system can monitor the at least one machine without internal machine parameters, such as engine parameters or hydraulic pressure values for example. Accordingly, the system can monitor the at least one machine without access to the internal machine parameters or internal machine data transmitted from a CAN-bus or similar device of the machine. The system can thereby be used with a wide variety of machines and also with machines from different manufacturers, as the system can monitor the processes and process environment performed by the machine independently of the internal machine parameters and the respective manufacturer of the machine. In this case, a connection of the at least one sensor unit attachable to the machine with the machine's control system is not necessary for the system to function.

Alternatively, the sensor unit can also have an interface that can be configured to communicate with the control system of a machine. This allows the system to access internal machine parameters or internal machine data as an additional source of information. For example, the at least one sensor unit may be configured to receive information from the CAN bus or similar device of a machine.

The at least one sensor unit can be configured to determine the information regarding the at least one machine continuously or intermittently. The at least one sensor unit can be configured to send the determined information to the evaluation unit in the form of specific time intervals. The determined information can, for example, be sent or made available for retrieval in real time or near real time. The at least one sensor unit can also be configured to store the determined information. If the at least one sensor unit cannot establish a connection to the at least one evaluation unit or vice versa, the at least one sensor unit can send the information at a later time at which a connection with the at least one evaluation unit can be established. Alternatively, the at least one evaluation unit can establish a connection to the at least one sensor unit and retrieve the information from the at least one sensor unit.

The at least one evaluation unit can be a spatially separate unit from the at least one sensor unit. The at least one sensor unit and the at least one evaluation unit can be configured to communicate wirelessly with each other. The at least one evaluation unit can be, for example, a server that is located at a different place than the at least one sensor unit. The sensor unit can transmit the information it determines to the at least one evaluation unit or make it available for retrieval by the at least one evaluation unit.

The at least one evaluation unit can be configured to determine the condition of at least one part of the machine using at least the image data generated by the at least one camera. For example, damage to the shovel of an excavator can be determined in this way. The image data determined by the camera can be used to determine damage to the machine so that maintenance respectively repair of the machine can be initiated and scheduled. Based on the determined condition of the machine, the maintenance requirement of the machine can be determined in advance, i.e. it can be determined whether and when maintenance of the machine is necessary. Based on the determined condition of the machine, the maintenance intervals of the machine can be adjusted accordingly.

The present invention further relates to a sensor arrangement for a system for monitoring at least one machine and its process environment. The sensor arrangement comprises at least one camera and at least one sensor unit. The at least one sensor unit has at least one device for detecting position information, at least one further sensor for detecting information relating to the machine and at least one control module which is configured at least for controlling the at least one camera.

The sensor arrangement can be arranged on a machine. The at least one sensor arrangement may be used in the system described above. The at least one camera and the at least one sensor unit may communicate with each other. The at least one sensor unit may communicate wirelessly or via cable with the at least one camera. The sensor unit may be configured to receive image data generated by the at least one camera. The sensor unit can send the information determined by it and/or the image data received from the camera to the evaluation unit or make it available to it for retrieval. The sensor unit can send the information determined by it and/or the image data received from the camera as raw data to the at least one evaluation unit or make it available to it for retrieval.

Besides the controlling of the at least one camera, the at least one control module of the sensor unit may also be configured to control the at least one device for acquiring the position information and the at least one further sensor. The control module can have at least one processor (CPU).

The at least one control module can be configured to control the at least one camera at least on the basis of the position information and/or the further information. The at least one camera can be configured so that the at least one camera can be controlled by the at least one evaluation unit.

The at least one control module can be configured to at least partially analyse the position information and/or the further information. Furthermore, the at least one control module can be configured to at least partially analyse the image data generated by the at least one camera. The information and/or image data analysed by the control module can be made available for retrieval and/or sent to the at least one evaluation unit. Besides the information analysed by the control unit, further information determined by the sensor unit and/or the image data can be provided as raw data for retrieval and/or sent to the at least one evaluation unit. The at least one control module can pre-analyse the determined information and transmit only the analysis result, whereby large information packages do not have to be transmitted or only partially. The at least one control module may have an unit with artificial intelligence.

The sensor arrangement can be arranged on different machines. The sensor arrangement can be used with machines from different manufacturers. Therefore, the sensor arrangement does not have to be installed in the machine ex works, but can be retrofitted without any problems. The sensor arrangement is very quick to install, as it only needs to be arranged in or on the machine.

The device for position detection of the sensor unit can be configured to determine position information via GNSS, Wifi, Bluetooth®, ultra-wide band (UWB), (mobile-) radio cells or via other radio standards.

The at least one sensor unit can have at least one communication module. The communication module can be configured for communication with the at least one camera. The at least one communication module can be configured for wireless communication with the at least one evaluation unit.

The at least one sensor unit may comprise at least one of the following sensors: gyroscope, accelerometer, magnetometer, barometer, humidity sensor, temperature sensor, microphone, ambient light sensors, proximity sensor, ultrasonic sensors, time-of-flight sensors. With these sensors, information regarding the at least one machine can be determined by the at least one sensor unit.

The at least one sensor unit can be configured to “wake up” at certain events concerning the machine or independent of the machine, for example when starting the machine on which it is arranged, and to go into the sleep state at further events, for example when switching off the machine. The “waking up” and the transfer in to sleep state of the sensor unit can be initiated, for example, by the accelerometer and/or the gyroscope and/or the power supply by the machine. In this way, the sensor unit is only active when the machine is in operation. Thereby energy can be saved. Likewise, the sensor unit may wake up or being transferred into asleep state by an internal clock at regular or specifiable intervals. Further, the at least one sensor unit may be awakened and put into sleep state by commands or commands. Such commands can be transmitted to the at least one sensor unit by SMS, for example.

The sensor unit may have an energy storage unit such as an accumulator or a battery for example, or may be connectable to a circuit of the machine on which it is arranged. For example, the at least one sensor unit may be connectable to the cigarette lighter of the machine. This makes the at least one sensor unit very quick to install in or on the machine. Alternatively, the at least one sensor unit may comprise an energy generation unit or be couplable to an energy generation unit. An energy generation unit can be formed by solar cells or a similar device.

The at least one sensor unit may have a capsulation. The at least one camera may have a capsulation. The at least one capsulation may be in the form of at least one housing in which the camera may be accommodated. The camera may be protected by the capsulation from, for example, rock fall, dirt and liquids. This applies in particular if the camera is attached on the outside of the machine. The sensor unit and the camera can be configured waterproof and/or dustproof with the capsulation.

The at least one sensor unit and/or the at least one camera may be attached on the machine. The at least one sensor unit and/or the at least one camera may be attached to the machine via at least one mount or a similar device.

The present invention further relates to a method for monitoring the processes performed by at least one machine and the process environment, whereby the method comprises the following steps of:

Determination of information relating to the at least one machine, wherein the determined information comprise at least one information from the following group: Position information of the machine, at least one speed value in at least one direction, at least one acceleration value in at least one direction,
generation of image data including at least a portion of the at least one machine and/or at least a section of the process environment of the at least one machine, and

Merging of the information determined with respect to the at least one machine and the image data for monitoring at least the processes executed by the at least one machine and the process environment.

An embodiment of the invention is described below with reference to the accompanying figures. It represents:

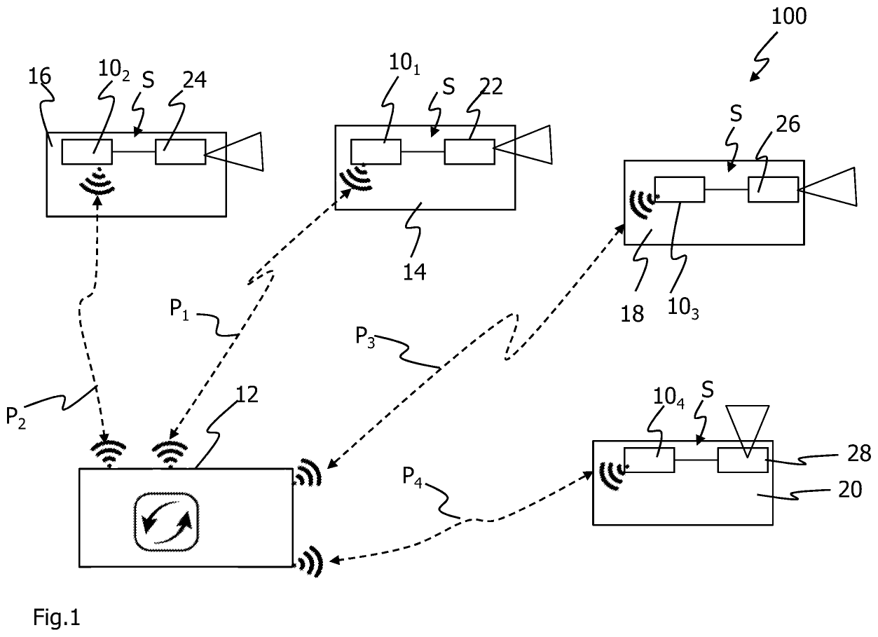

FIG. 1 a schematic view of a system for monitoring the processes performed by at least one machine and the process environment; and

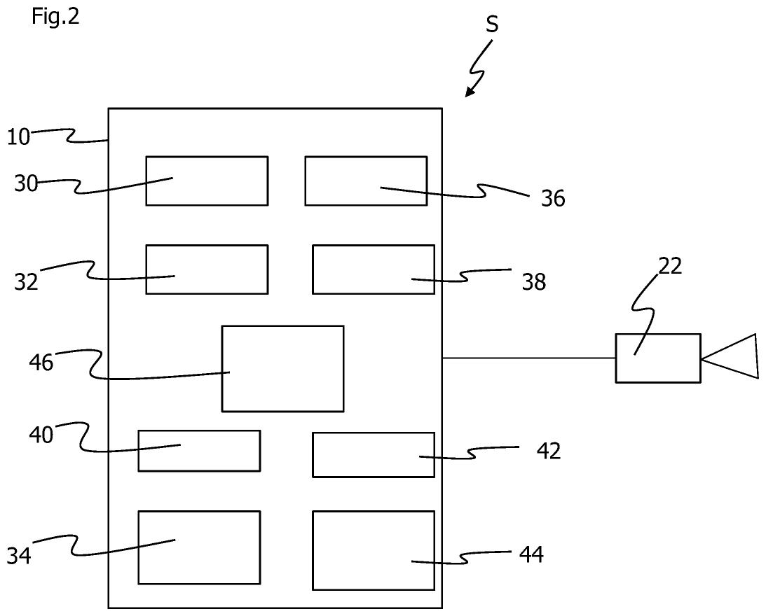

FIG. 2 schematic view of a sensor arrangement.

FIG. 1 shows a schematic view of a system 100 for monitoring the processes carried out by at least one machine and the process environment. The system 100 according to this embodiment has four sensor units 101, 102, 103, 104 and an evaluation unit 12. The sensor units 101, 102, 103, 104 can communicate wirelessly with the evaluation unit 12. The wireless communication between the sensor units 101, 102, 103, 104 and the evaluation unit 12 is shown in FIG. 1 by the arrows P1, P2, P3 and P4. For example, the communication between the sensor units 101, 102, 103, 104 and the evaluation unit 12 can take place via radio networks and in particular mobile radio networks. However, other communication protocols respectively communication methods are also conceivable, such as Wifi or Bluetooth®, which enable wireless communication. Furthermore, the sensor units 101, 102, 103, 104 can also communicate wirelessly with each other. The sensor units 101, 102, 103, 104 may be identical.

The evaluation unit 12 can be a server, for example. The evaluation unit 12 can be arranged in the immediate periphery of the sensor units 101, 102, 103, 104. However, the evaluation unit 12 can also be located in a different place than the sensor units 101, 102, 103, 104. For example, the evaluation unit 12 can be positioned in a central data centre or server centre. The sensor units 101, 102, 103, 104 can send the information determined by them to the evaluation unit 12. Alternatively, the sensor units 101, 102, 103, 104 can also provide the information determined by them for retrieval by the evaluation unit 12. For this purpose, the sensor units 101, 102, 103, 104 can send the determined information to the evaluation unit 12 in predetermined time intervals or provide it for retrieval by the evaluation unit 12 in predetermined time intervals. If the sensor units 101, 102, 103, 104 cannot establish a connection with the evaluation unit 12, the information determined by the sensor units 101, 102, 103, 104 can then be sent again to the evaluation unit 12 or made available for retrieval when a connection can be established with the evaluation unit 12.

The sensor units 101, 102, 103, 104 are arranged on machines 14, 16, 18, 20. The machines 14, 16, 18 and 20 are located at different places of the construction site or mining site. For example, machine 14 may be a dump truck. Machine 16 may be a hydraulic excavator and machine 18 may be another dump truck. The machine 20 may be a wheel loader. Accordingly, the sensor units 101, 102, 103, 104 may be attached to different types of machines and may determine information about the machine 14, 16, 18, 20 to which they are attached, regardless of the type and manufacturer of the machine.

Besides the sensor units 101, 102, 103, 104, cameras 22, 24, 26, 28 are arranged on the machines 14, 16, 18 and 20. A sensor unit 101, 102, 103, 104 and a camera 22, 24, 26 and 28 are thus arranged on each machine 14, 16, 18, 20. Each of the cameras 22, 24, 26 and 28 is assigned to one of the sensor units 101, 102, 103, 103. The sensor units 101, 102, 103, 104 and the cameras 22, 24, 26 and 28 can communicate with each other, as indicated schematically by the connecting lines. The communication between the sensor units 101, 102, 103, 104 and the cameras 22, 24, 26, 28 may be wireless. Accordingly, each machine 14, 16, 18, 20 is equipped with a sensor arrangement S formed by one of the sensor units 101, 102, 103, 104 and one of the cameras 22, 24, 26, 28.

Each of the cameras 22, 24, 26, 28 generates image data containing at least a portion of the machine 14, 16, 18, 20 and/or a section of the process environment of the at least one machine 14, 16, 18, 20. The image data generated by the cameras 22, 24, 26, 28 may be transmitted to the sensor unit 101, 102, 103, 104 associated with the respective camera 22, 24, 26, 28. Each of the sensor units 101, 102, 103, 104 can control its associated camera 22, 24, 26, 28.

The sensor units 101, 102, 103, 104 are independent of the controls of the machines 14, 16, 18, 20, i.e. the sensor units 101, 102, 10, 104 are not connected to the controls of the machines 14, 16, 18, 20. The sensor units 101, 102, 103, 104 may only be connected to the circuit of the machines 14, 16, 18, 20 to be supplied with energy. However, the sensor units 101, 102, 103, 104 may also have an energy storage unit, so that the sensor units 101, 102, 103, 104 are independent of the machines 14, 16, 18, 20 and thus self-sufficient units.

Each of the sensor units 101, 102, 103, 104 determines information about the machine 14, 16, 18, 20 to which the respective sensor unit 101, 102, 103, 104 is attached. For example, the sensor units 101, 102, 103, 104 may determine information about the position, acceleration, speed and orientation or location of the machine or parts of the machines 14, 16, 18, 20. Each of the cameras 22, 24, 26, 28 generates image data about the machine 14, 16, 18, 20 on which the respective camera 22, 24, 26, 28 is attached and its process environment. The image data from the cameras 22, 24, 26, 28 are transmitted to the respective sensor unit 101, 102, 103, 104. The sensor units 101, 102, 103, 104 can send the information they collect and the image data generated by one of the cameras 22, 24, 26, 28 to the evaluation unit 12 or provide it to the evaluation unit 12 for retrieval.

The evaluation unit 12 can combine the information determined by one of the sensor units 101, 102, 103, 104 and the image data generated by one of the cameras 22, 24, 26, 28 relating to one of the machines 14, 16, 18, 20 in order to be able to analyse the processes carried out by the at least one machine 14, 16, 18, 20 and the process environment.

FIG. 2 shows a schematic view of a sensor arrangement S comprising a sensor unit 10 and a camera 22. The sensor unit 10 can communicate with the camera 22. The sensor unit 10 comprises a device 30 for acquiring position information, a communication module 32, an acceleration sensor 34, a gyroscope 36, a magnetometer 38, a barometer 40 and a thermometer 42. The device 30 for acquiring the position information may be adapted to acquire the position information, for example, via GNSS and/or using Wifi routers. The sensor unit 10 may comprise a memory module 44. The communication module 32 may be configured to communicate with the evaluation unit 12 and/or the camera 22.

The sensor unit 10 has a control module 46 that controls the camera 22. The control module 46 may, for example, control the camera based on the information it determines and may, for example, instruct the camera to generate image data at a particular point in time or in response to a determined event. The camera 22 may communicate the image data it generated to the sensor unit 10 and/or to the control module 46. The control module 46 may further control the device 30, the communication module 32, the sensors 34 to 42, and the memory module 44.

The memory module 44 can store the information determined by the sensor unit with respect to the machine on which the sensor unit 10 is arranged. The sensor unit 10 may further have an energy storage module so that the sensor unit 10 is an independent and thus self-sufficient unit from the respective machine. Alternatively, however, the sensor unit 10 can also be configured to be connected to a circuit of a machine so that the power supply of the sensor unit 10 is provided via the machine. The sensor unit 10 can also have an interface that can be configured for communication with the control of a machine.

With the system 100 according to the invention and the sensor arrangement S according to the invention, the processes carried out by a machine 14, 16, 18, 20 and the process environment can be monitored substantially without gaps in real time or at least in near real time even at the most remote locations of use. The information determined by the sensor unit 10 and the image data generated by the camera 22, 24, 26, 28 can be merged by the evaluation unit 12 independent of the operating location of the machine 14, 16, 18, 20 in order to be able to monitor the processes carried out by the machine 14, 16, 18, 20 and the process environment of the machine 14, 16, 18, 20.

1. A system (100) for monitoring the processes performed by at least one machine (14, 16, 18, 20) and the process environment, the system (100) comprising:
at least one sensor unit (10), the at least one sensor unit (10) being configured to determine information relating to the at least one machine (14, 16, 18, 20), the information determined by the at least one sensor unit (10) comprising at least one item of information from the following group: Position information of the machine (14, 16, 18, 20), at least one speed value in at least one direction, at least one acceleration value in at least one direction,
at least one camera (22, 24, 26, 28) generating image data comprising at least a portion of the at least one machine (14, 16, 18, 20) and/or at least a section of the process environment of the at least one machine (14, 16, 18, 20), and
at least one evaluation unit (12), the at least one evaluation unit (12) being configured to merge the information determined by the at least one sensor unit (10) and the image data generated by the at least one camera (22, 24, 26, 28) at least for monitoring the processes carried out by the at least one machine (14, 16, 18, 20) and the process environment.

2. System (100) according to claim 1,
wherein the at least one evaluation unit (12) is configured to merge the information determined by the at least one sensor unit (10) and the image data generated by the at least one camera (22, 24, 26, 28) in order to determine a process profile of the processes carried out by the at least one machine (14, 16, 18, 20).

3. System (100) according to claim 1 or 2,
wherein the at least one evaluation unit (12) is configured to merge the information determined by the at least one sensor unit (10) and the image data generated by the at least one camera (22, 24, 26, 28) in order to determine information about the process environment of the at least one machine (14, 16, 18, 20).

4. System (100) according to any one of claims 1 to 3,
wherein the at least one sensor unit (10) is configured to control the at least one camera.

5. System (100) according to claim 4,
wherein the at least one sensor unit (10) is configured to control the at least one camera (22, 24, 26, 28) in dependence on at least one event detected by the sensor unit (10).

6. System (100) according to any one of claims 1 to 5,
wherein the at least one evaluation unit (12) is configured to assign an image or an image sequence of the image data generated by the at least one camera (22, 24, 26, 28) with at least one item of information determined by the at least one sensor unit (10).

7. System (100) according to any one of claims 1 to 6,
wherein the at least one evaluation unit (12) is configured to determine the state of at least one section of the machine (14, 16, 18, 20) at least on the basis of the image data generated by the at least one camera (22, 24, 26, 28).

8. System (100) according to any one of claims 1 to 7,
wherein the at least one evaluation unit (12) is configured to determine at least the type and/or at least one characteristic of the material processed or handled by the at least one machine (14, 16, 18, 20) based on the image data generated by the at least one camera (22, 24, 26, 28) and the information determined by the at least one sensor unit (10).

9. System (100) according to any one of claims 1 to 8,
wherein the at least one evaluation unit (12) is configured to determine information patterns in the information determined by the at least one sensor unit (10), wherein the at least one evaluation unit (12) is configured to assign the image data generated by the at least one camera (22, 24, 26, 28) to one or more determined information patterns.

10. System (100) according to any one of claims 1 to 9,
wherein the at least one camera (22, 24, 26, 28) transmits the image data generated by it to the at least one sensor unit (10) and/or to the at least one evaluation unit (12).

11. System (100) according to any one of claims 1 to 10,
wherein the at least one camera (22, 24, 26, 28) and/or the at least one sensor unit (10) can be or are arranged on the at least one machine (14, 16, 18, 20).

12. System (100) according to any one of claims 1 to 11,
wherein the at least one camera and/or the at least one sensor unit are arranged stationary at a predetermined location.

13. System (100) according to any one of claims 1 to 12,
wherein the at least one evaluation unit (12) comprises at least one artificial intelligence unit.

14. System (100) according to any one of claims 1 to 13,
wherein the system (100) comprises a plurality of sensor units (10) and/or a plurality of cameras (22, 24, 26, 28), wherein at least some of the sensor units (10) and/or some of the cameras (22, 24, 26, 28) are arrangeable or arranged on a machine (14, 16, 18, 20).

15. System (100) according to any one of claims 1 to 14,
wherein the at least one evaluation unit (12) is configured to determine two or more interacting machines (14, 16, 18, 20) on the basis of the information determined by the plurality of sensor units (10) and the image data generated by the at least one camera (22, 24, 26, 28).

16. System (100) according to any one of claims 1 to 15,
wherein the at least one evaluation unit (12) is configured to recognise objects in the image data generated by the at least one camera (22, 24, 26, 28).

17. System (100) according to claim 16,
wherein the at least one evaluation unit (12) is configured to recognise persons in the image data generated by the at least one camera (22, 24, 26, 28) and to render them unrecognisable.

18. system (100) according to claim 16 or 17,
wherein the at least one evaluation unit (12) is configured to recognise machines (14, 16, 18, 20) in the image data generated by the at least one camera (22, 24, 26, 28) and to distinguish the machines (14, 16, 18, 20) according to their respective machine type.

19. A sensor arrangement (S) for a system (100) for monitoring the processes performed by at least one machine (14, 16, 18, 20) and the process environment, the sensor arrangement (10) comprising:
at least one camera (22, 24, 26, 28), the camera (22, 24, 26, 28) generating image data, and
at least one sensor unit (10), the at least one sensor unit (10) having at least one device (30) for detecting position information, at least one further sensor (34, 36, 38, 40) for detecting information relating to the machine (14, 16, 18, 20) and at least one control module (46) which is configured at least for controlling the at least one camera (22, 24, 26, 28).

20. Sensor arrangement (S) according to claim 19,
wherein the at least one control module (46) is configured to control the at least one camera (22, 24, 26, 28) at least on the basis of the position information and/or the further information.

21. Sensor arrangement (S) according to claim 19 or 20,
wherein the at least one sensor unit (10) is configured to receive the image data generated by the at least one camera (22, 24, 26, 28).

22. Sensor arrangement (S) according to any one of claims 19 to 21,
wherein the at least one control module (46) is configured to analyse the position information and/or the further information, and/or wherein the at least one control module (46) is adapted to analyse the image data generated by the at least one camera (22, 24, 26, 28).

23. Sensor arrangement (S) according to any one of claims 19 to 22,
wherein the at least one control module (46) comprises at least one artificial intelligence module.

24. Sensor arrangement (S) according to any one of claims 19 to 23,
wherein the at least one further sensor (34, 36, 38, 40, 42) is one of the following sensors: gyroscope, accelerometer, magnetometer, barometer, humidity sensor, temperature sensor, microphone, ambient light sensors, proximity sensor, ultrasonic sensors, time-of-flight sensors.

25. Sensor arrangement (S) according to any one of claims 19 to 24,
wherein the at least one sensor unit (10) and/or the at least one camera (22, 24, 26, 28) comprise at least one encapsulation.

26. A method of monitoring the processes performed by at least one machine (14, 16, 18, 20) and the process environment, the method comprising:
determination of information relating to the at least one machine (14, 16, 18, 20), the determined information comprising at least one information from the following group: Position information of the machine (14, 16, 18, 20), at least one speed value in at least one direction, at least one acceleration value in at least one direction,
generation of image data comprising at least a section of the at least one machine (14, 16, 18, 20) and/or at least a part of the process environment of the at least one machine (14, 16, 18, 20), and
merging of the determined information and the image data to monitor at least the processes performed by the at least one machine (14, 16, 18, 20) and the process environment.
